(19) United States
(12) Patent Application Publication
(10) Pub. No.: US 2026/0278283 A1
(43) Pub. Date: Sep. 17, 2026

(54) PROACTIVE CONVERSATIONAL AGENT FOR MULTI-PARTY CONVERSATIONS

(71) Applicant: International Business Machines Corporation, Armonk, NY (US)

(72) Inventors: Steven I. Ross, South Hamilton, MA (US); Stephanie Houde, Belmont, MA (US); Dario Andres Silva Moran, Joaquin Gorina (AR); Michael Muller, Medford, MA (US); Siya Kunde, Pleasantville, NY (US); Kristina Marie Brimijoin, Hastings on Hudson, NY (US); Gabriel Enrique Gonzalez, Necochea (AR)

(21) Appl. No.: 19/081,593

(22) Filed: Mar. 17, 2025

(51) Int. Cl. G06F 40/35

(52) U.S. Cl. CPC G06F 40/35

(57) ABSTRACT

A system includes a processor that executes computer executable components stored in a memory. The computer executable components can comprise a conversational agent that participates in a multi-party conversation, and that interacts with other system components. The computer executable components can further comprise an analysis component that analyzes a multi-party conversation in real time. The computer executable components can further comprise a generation component that generates a response for a conversational agent. The computer executable components can further comprise an evaluation component that assigns a value to the generated response. The computer executable components can further comprise a decision component that determines whether to contribute the generated response to the multi-party conversation.

### TECHNICAL FIELD

The subject disclosure relates to conversational agents, particularly in the context of multi-party conversations, e.g., systems that analyze interactions among multiple participants to determine appropriate response timing and relevance.

### BACKGROUND

Conversational agents, or chatbots, have become an increasingly prevalent tool for user interaction across various platforms. The development of large language models (LLMs) has significantly enhanced the sophistication and flexibility of conversational agents, allowing for the generation of more contextually relevant and natural-sounding responses. However, despite these improvements, current conversational agent systems are primarily designed for isolated, single-user sessions, where every user message prompts a direct response from a conversational agent.

In multi-party conversations, such as group chats, forums, or collaborative discussions, a conventional approach becomes problematic. A conversational agent that responds to every message indiscriminately can generate irrelevant, excessive, or disruptive contributions, overwhelming human participants and reducing overall effectiveness of a conversation. Existing solutions risk distracting users, overwhelming conversations with unnecessary responses, or failing to engage at appropriate moments.

### SUMMARY

The following presents a summary to provide a basic understanding of some embodiments of the invention. This summary is not intended to identify key or critical elements or delineate any scope of the particular embodiments or any scope of the claims. Its sole purpose is to present concepts in a simplified form as a prelude to the more detailed description that is presented later. In some embodiments described herein, systems, computer-implemented methods, and/or computer program products that facilitate conversational agent participation in a multi-party conversation are provided.

According to an embodiment, a system can comprise a processor that executes computer executable components stored in memory. The computer executable components can comprise a conversational agent that participates in a multi-party conversation, and that interacts with other system components. The computer executable components can further comprise an analysis component that analyzes the multi-party conversation in real time. The computer executable components can further comprise a generation component that generates a response for the conversational agent. The computer executable components can further comprise an evaluation component that assigns a value to the generated response. The computer executable components can further comprise a decision component that determines whether to contribute the generated response to the multi-party conversation.

According to another embodiment, a computer-implemented method can comprise analyzing, by a system operatively coupled to a processor, a multi-party conversation in real time. The computer-implemented method further comprises generating, by a system, a response for a conversational agent. The computer-implemented method can further comprise assigning, by the system, a value to the generated response. The computer-implemented method can further comprise determining, by the system, whether to contribute the generated response to the multi-party conversation.

According to another embodiment, a computer program product comprising a computer readable storage medium having program instructions embodied therewith, the program instructions executable by a processor to cause the processor to analyze, by the processor, a multi-party conversation in real time. The program instructions can also cause the processor to generate, by the processor, a response for a conversational agent. The program instructions can also cause the processor to assign, by the processor, a value to the generated response. The program instructions can also cause the processor to determine, by the processor, whether to contribute the generated response to the multi-party conversation.

### BRIEF DESCRIPTION OF THE DRAWINGS

FIGS. 1 and 2 illustrate example systems that can facilitate conversational agent participation in a multi-party conversation in accordance with some embodiments described herein.

FIG. 3 illustrates a flow diagram of a method 300 that can facilitate conversational agent participation in a multi-party conversation in accordance with some embodiments described herein.

FIG. 4 illustrates a flow diagram of a method 400 that can facilitate conversational agent participation in a multi-party conversation in accordance with some embodiments described herein.

FIG. 5 illustrates an example of feedback on a conversational agent's response within a multi-party conversation, in accordance with some embodiments described herein.

FIG. 6 illustrates an example of a multi-party conversation where a conversational agent is directly targeted, in accordance with some embodiments described herein.

FIG. 7 illustrates an example system workflow for a conversational agent's participation in a multi-party conversation in accordance with some embodiments described herein.

FIG. 8 illustrates a block diagram of an example computing environment that can facilitate some embodiments described herein.

### DETAILED DESCRIPTION

The following detailed description is merely illustrative and is not intended to limit embodiments, applications, and/or uses of embodiments. Furthermore, there is no intention to be bound by any expressed or implied information presented in the preceding Background or Summary sections, or in the Detailed Description section.

The use of conversational agents has become increasingly prevalent across various digital communication platforms. With the development of large language models (LLMs), modern conversational agents have achieved greater sophistication in generating human-like responses. These advancements have enhanced chatbot functionality in single-user interactions, where a conversational agent engages in a controlled, one-on-one exchange and provides responses based on individual inputs. However, existing conversational agent architectures remain largely optimized for such isolated interactions, limiting their applicability in multi-party conversations, where multiple participants can contribute messages within a shared conversational space.

In multi-party environments, traditional conversational agent mechanisms become inefficient and disruptive. Traditional conversational agents in group conversation contexts often generate redundant or irrelevant contributions, leading to excessive interjections or unnecessary interruptions. These shortcomings create a need for an improved conversational agent framework capable of intelligently determining the agent's participation in a multi-party conversation based on contextual factors.

To address these challenges, the present disclosure provides a proactive conversational agent system designed to operate effectively within multi-party conversations. Innovations disclosed herein introduce an intelligent decision-making framework that allows a conversational agent to determine when and whether to contribute based on factors such as direct targeting, conversational context, timing, or participant engagement. Unlike traditional conversational agents, which generate responses indiscriminately, the disclosed system is configured to engage in a conversation only when appropriate, attempting to enhance rather than disrupt the flow of a discussion.

A proactive conversational agent for multi-party conversations can be beneficial in various contexts, including, but not limited to, workplace collaboration, customer support, virtual meetings, educational discussions, and gaming environments. For example, a conversational agent can assist team collaboration in workplace chat platforms by summarizing discussions, tracking action items, or answering queries without disrupting ongoing conversations. Additionally, in some embodiments, a conversational agent can act as a fact checker in chat platforms preventing miscommunication among team members.

A method by which a conversational agent can decide when and whether to contribute to an ongoing multi-user conversation can occur in multiple phases. In an initial phase, a decision can be made about whether to generate a potential response to a conversation. This can occur after each user's contribution to a conversation is received, and potentially at other times such as when no contributions to the discussion have taken place for some period of time, or when some relevant monitored external event is detected. If a decision to generate a response is positive, subsequent phases can be engaged. In another phase, a user contribution can be analyzed to determine its source and target. During a next phase, a potential response can be generated. In a proceeding phase, a response can be evaluated for its value and appropriateness to the conversation. Finally, a final decision can be taken about whether to proceed with a proposed response, or whether it would be preferable to remain silent based on a current context. This decision can determine whether a response is contributed to a conversation.

In relation to conversional agent participation in multi-party conversations, embodiments disclosed herein produce a solution to one or more of these problems. These embodiments can solve such problems by analyzing a multi-party conversation in real time; by generating a response for a conversational agent; by assigning a value to the generated response; by determining whether to contribute the generated response to the multi-party conversation.

According to an embodiment, a system can include a processor that executes computer executable components stored in a memory. The computer executable components can comprise a conversational agent that participates in a multi-party conversation, and that interacts with other system components. The computer executable components can further comprise an analysis component that analyzes the multi-party conversation in real time. The computer executable components can further comprise a generation component that generates a response for the conversational agent. The computer executable components can further comprise an evaluation component that assigns a value to the generated response. The computer executable components can further comprise a decision component that determines whether to contribute the generated response to the multi-party conversation.

In some embodiments, the system can further comprise a feedback component that receives feedback on the sufficiency of the response.

In some embodiments, the analysis component can be responsible for continuously monitoring the multi-party conversation by processing incoming dialogue data in real time. The analysis component can identify key contextual elements, such as speaker identity, sentiment, conversation flow, or relevance of prior utterances. The analysis component can evaluate whether a conversational agent should respond based on predefined criteria, including direct engagement cues (e.g., being addressed by name), contextual relevance of the discussion, or conversational intent signals. The analysis component can incorporate linguistic models, natural language understanding (NLU) techniques, or discourse analysis to assess an evolving conversation state, ensuring that generated responses align with the conversation's context and objectives. In various embodiments, the analysis component can instruct a generation component to generate a conversational agent response.

In some embodiments, the generation component can create candidate responses for a conversational agent based on the insights provided by the analysis component. The generation component can construct responses that align with a conversation's context, tone, and objectives. By leveraging various response generation techniques, the generation component can enable a conversational agent to provide meaningful and coherent contributions to a conversation.

In some embodiments, the evaluation component can assess the quality, relevance, and appropriateness of a generated response before it is contributed to a conversation. The evaluation component can assign a value to the response based on predefined criteria, ensuring that only responses meeting a certain standard are considered for contribution. This evaluation process can help maintain effectiveness and coherence of a conversational agent's interactions. According to some embodiments, the evaluation component can determine the value of the response based on a combination of algorithmic and generative decision-making criteria.

In some embodiments, the decision component can determine whether a generated response should be contributed to the multi-party conversation. The decision component can compare the response's assigned value to a threshold and consider additional contextual factors such as timing, participant engagement, and conversation flow. By regulating frequency and nature of a conversational agent's responses, the decision component can ensure that contributions enhance a conversation rather than disrupt it.

In some embodiments, the decision component can determine whether the assigned value is above a threshold. The threshold can adjust how frequently or to what extent a conversational agent contributes to a multi-party conversation. This capability can allow customization so different applications can tune a conversational agent's behavior to fit conversation needs. In various embodiments, the threshold can be based on at least one of or more: a minimum value amount, a minimum time between responses, a maximum acceptable response length, a relevant criterion associated with conversation dynamics, a user characteristic, or a contextual factor external to the multi-party conversation. A minimum value amount can prevent a conversational agent from responding to low-priority or redundant messages. A minimum time between responses can enforce a time delay between conversational agent contributions to avoid overwhelming a conversation. A maximum acceptable response length can limit how long a response can be to prevent overly verbose or disruptive messages. A relevant criterion associated with conversation dynamics can include factors such as a conversational turn-taking sequence, a sentiment analysis of previous exchanges, or a conversational agent's role within a dialogue. For example, in professional discussions, a conversational agent may prioritize responses that align with a discourse's formal tone and structure. A user characteristic can include attributes such as user expertise level, engagement history, or preferences for interaction style. For instance, a system interacting with a novice user may prioritize more detailed explanations, whereas an expert may receive more concise responses. A contextual factor external to the multi-party conversation may include real-world events, environmental conditions, or situational constraints that influence necessity or relevance of a response. For example, in an emergency scenario, a conversational agent may prioritize brevity and urgency, whereas in a casual chat setting, it may allow for more flexible and engaging interactions.

In various embodiments, the decision component can determine that the value is below the threshold, and the system can suppress the response. In various embodiments, the decision component can determine that the value is above the threshold, and the system can contribute the response to the multi-party conversation. According to some embodiments, the decision component can contribute the response to the multi-party conversation when a conversational agent is directly targeted. In various embodiments, the decision component can determine whether to contribute a response based on at least one of or more: a target agent, a target participant, additional messages received, timing, a length of response, or a simultaneous input. The decision component can analyze whether the conversational agent was being explicitly requested to respond (as it was a target of a message) or whether a message was directed at another specific user (target participant) in which case the conversational agent should not respond. A system can also consider whether additional messages provide more context before generating a response or whether timing of a message suggests a natural point for a conversational agent to interject. For example, detecting lulls in the conversation can provide an opportunity for the conversational agent to make contributions to keep a conversation moving along. Additionally, constraints such as length of a message and concurrent inputs from multiple participants can be used to determine whether a conversational agent's contribution would enhance or disrupt a multi-party conversation. By considering these factors, a system can attempt to ensure that a conversational agent engages only when its input is contextually appropriate and beneficial to a discussion.

In various embodiments, a feedback component can receive feedback on sufficiency of the response.

Advantages of this system can include improved context-aware participation, reduced computational overhead, or enhanced user experience in multi-party conversations.

According to some embodiments, the above-described computer system may be implemented as a computer-implemented method or as a computer program product.

Some embodiments of the present disclosure are now described with reference to the drawings. In the drawings, referenced numerals are used to refer to like elements throughout. In the following description, for purposes of explanation, numerous specific details are set forth in order to provide a more thorough understanding of the embodiments. In various cases, some embodiments may be practiced without these specific details, yet a person having ordinary skill in the art will recognize that such embodiments are within metes and bounds of this disclosure.

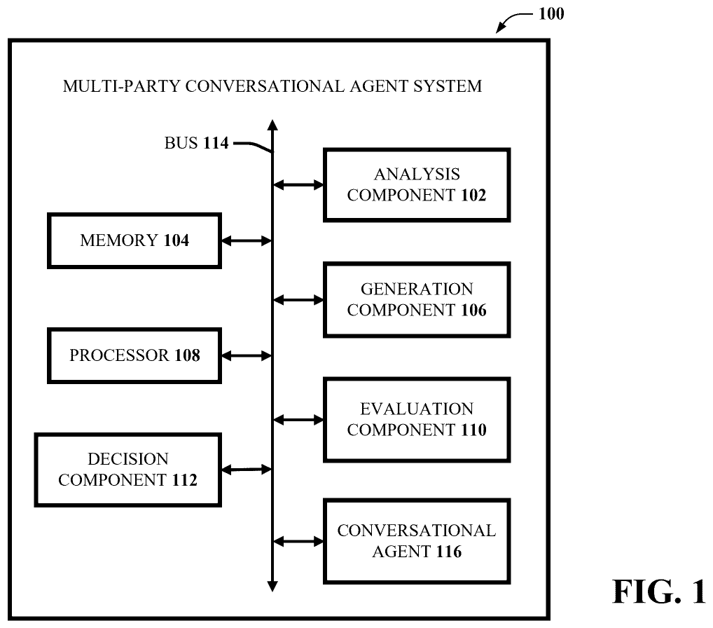

FIG. 1 illustrates an example system 100 for facilitating conversational agent participation in a multi-party conversation. System 100 uses a conversational agent, an analysis component, a generation component, an evaluation component, and a decision component. The conversational agent can participate in a multi-party conversation, and interact with other system components. The analysis component can analyze the multi-party conversation in real time. The generation component can generate a response for the conversational agent. The evaluation component can assign a value to the generated response. The decision component can determine whether to contribute the generated response to the multi-party conversation.

Aspects of systems (e.g., systems 100, 200, and the like), apparatuses, or processes in various embodiments of the present disclosure can constitute one or more machine-executable components embodied within one or more machines. For example, the components may be embodied in one or more computer readable mediums (or media) associated with one or more machines. Such components, when executed by one or more machines (e.g., computers, computing devices, virtual machines, etc.) can cause the machines to perform the operations described. System 100 may comprise a conversational agent 116, an analysis component 102, a memory 104, a generation component 106, a processor 108, an evaluation component 110, a decision component 112, and a system bus 114.

The system 100 and/or the components of the system 100 can use hardware and/or software to solve problems that are highly technical in nature. System 100 solves problems that are not abstract and that cannot be performed as a set of mental acts by a human. Further, some of the processes may be performed by specialized computers for carrying out defined tasks related to recovery plan development. The system 100 and/or components of the system 100 can be employed to solve new problems that arise through advancements in technologies. The system 100 can provide technical improvements to the multi-party conversation by ensuring that discussions are more structured, informative, and productive, while reducing cognitive load on participants.

System 100 can include a processor 108. In some embodiments, the processor 108 can execute a component or subcomponent associated with the system 100. Components or subcomponents associated with the system 100 can include one or more machine readable, writable, and/or executable instructions. In some embodiments, the system 100 can include a memory 104, and the memory 104 can store one or more components and/or subcomponents associated with the system 100. In some embodiments, the processor 108 can execute a component stored in the memory 104.

In some embodiments, the system 100 can include a computer-readable memory 104 that can be operably connected to the processor 108. The memory 104 can store computer-executable instructions that, upon execution by the processor 108, may cause the processor 108 and/or one or more other components of the system 100 (e.g., the conversational agent 116, the analysis component 102, the generation component 106, the evaluation component 110, and/or decision component 112) to perform one or more actions. In some embodiments, the memory 104 can store computer-executable components (e.g., the conversational agent 116, the analysis component 102, the generation component 106, the evaluation component 110, and/or decision component 112).

The system 100 and/or a component thereof as described herein can be communicatively, electrically, operatively, optically, and/or otherwise coupled to one another via a bus 114. The bus 114 can include one or more of a memory bus, memory controller, peripheral bus, external bus, local bus, and/or another type of bus that can employ one or more bus architectures. In some embodiments, the system 100 can be coupled (e.g., communicatively, electrically, operatively, optically, and/or the like) to one or more external systems (e.g., an electrical output production system, one or more output targets, an output target controller, and/or the like). In some embodiments, the system 100 can be coupled to one or more external sources, and/or devices (e.g., classical computing devices, communication devices, and/or like devices), such as via a network. In some embodiments, one or more of the components of the system 100 can reside in the cloud and/or locally in a local computing environment (e.g., at one or more specified locations).

In addition to the processor 108 and/or the memory 104 described above, the system 100 can include one or more computer and/or machine readable, writeable, and/or executable components and/or instructions. When executed by the processor 108, these components and/or instructions can enable performance of one or more operations defined by the component(s) and/or instruction(s).

In some embodiments, the analysis component 102 can instruct a generation component 106 to generate a conversational agent response. In some embodiments, if the analysis component 102 determines that a conversational agent response is warranted, such as when a conversational agent is directly targeted, the analysis component 102 can prompt the generation component 106 accordingly.

According to some embodiments, the evaluation component 110 can determine the value of the response based on a combination of algorithmic and generative decision-making criteria.

In some embodiments, the decision component 112 can determine whether the assigned value is above a threshold. The threshold can adjust how frequently or to what extent a conversational agent contributes to a multi-party conversation. This capability can allow customization so different applications can tune a conversational agent's behavior to fit conversation needs. In various embodiments, the threshold can be based on at least one of or more: a minimum value amount, a minimum time between responses, a maximum acceptable response length, a relevant criterion associated with conversation dynamics, a user characteristic, or a contextual factor external to the multi-party conversation. A minimum value amount can prevent a conversational agent from responding to low-priority or redundant messages. A minimum time between responses can enforce a time delay between conversational agent contributions to avoid overwhelming a conversation. A maximum acceptable response length can limit how long a response can be to prevent overly verbose or disruptive messages. A relevant criterion associated with conversation dynamics can include factors such as a conversational turn-taking sequence, a sentiment analysis of previous exchanges, or a conversational agent's role within a dialogue. For example, in professional discussions, a conversational agent may prioritize responses that align with a discourse's formal tone and structure. A user characteristic can include attributes such as user expertise level, engagement history, or preferences for interaction style. For instance, a system interacting with a novice user may prioritize more detailed explanations, whereas an expert may receive more concise responses. A contextual factor external to the multi-party conversation may include real-world events, environmental conditions, or situational constraints that influence necessity or relevance of a response. For example, in an emergency scenario, a conversational agent may prioritize brevity and urgency, whereas in a casual chat setting, it may allow for more flexible and engaging interactions.

In some embodiments, the decision component 112 can determine that the value is below the threshold, and the system can suppress the response. In various embodiments, the decision component 112 can determine that the value is above the threshold, and the system can contribute the response to the multi-party conversation. According to some embodiments, the decision component 112 can contribute the response to the multi-party conversation when a conversational agent is directly targeted. In various embodiments, the decision component 112 can determine whether to contribute a response based on at least one of or more: a target agent, a target participant, additional messages received, timing, a length of response, or a simultaneous input. The decision component 112 can analyze whether the conversational agent was being explicitly requested to respond (as it was a target of a message) or whether a message was directed at another specific user (target participant) in which case the conversational agent should not respond. A system can also consider whether additional messages provide more context before generating a response or whether timing of a message suggests a natural point for a conversational agent to interject. For example, detecting lulls in the conversation can provide an opportunity for the conversational agent to make contributions to keep a conversation moving along. Additionally, constraints such as length of a message and concurrent inputs from multiple participants can be used to determine whether a conversational agent's contribution would enhance or disrupt a multi-party conversation. By considering these factors, a system can attempt to ensure that a conversational agent engages only when its input is contextually appropriate and beneficial to a discussion.

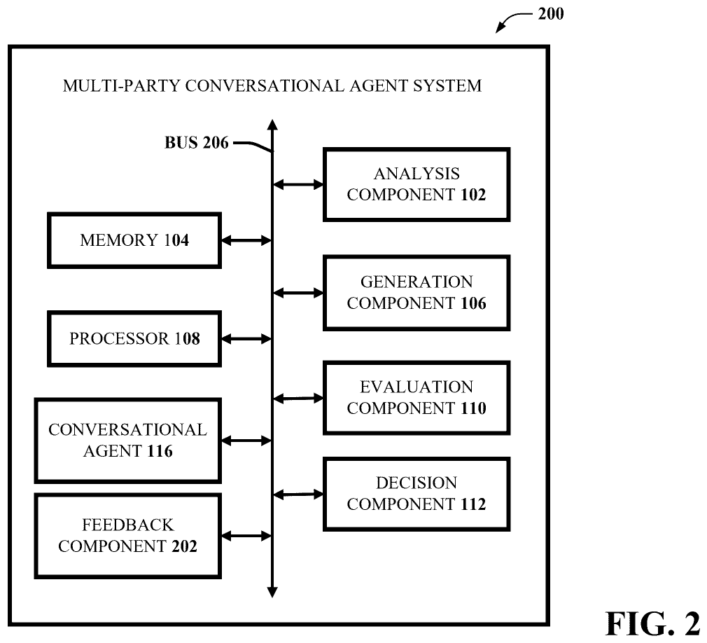

FIG. 2 illustrates an example system 200 that can facilitate conversational agent participation in a multi-party conversation. System 200 uses conversational agent 116, analysis component 102, generation component 106, evaluation component 110, decision component 112, and feedback component 202. The conversational agent 116 can participate in a multi-party conversation, and interact with other system components. The analysis component 102 can analyze the multi-party conversation in real time. The generation component 106 can generate a response for the conversational agent. The evaluation component can assign a value to the generated response. The decision component can determine whether to contribute the generated response to the multi-party conversation. Description of like components has been omitted for the sake of brevity.

In various embodiments, feedback component 202 can receive feedback on sufficiency of the response. Feedback component 202 can collect feedback to improve the quality and effectiveness of a conversational agent's response. Feedback can come from various sources such as user feedback (e.g., comment or rating), implicit signals (e.g., whether a user asks a follow-up question, ignores a response, or rephrases a query), or system monitoring (e.g., whether a response led to a resolved conversation or further discussion). Based on feedback, a system can detect or correct errors, adjust future responses, adjust contribution thresholds or refine a response generation model.

The systems and/or devices are described herein with respect to interaction between one or more components. Such systems and/or components can include the components and/or sub-components specified therein, one or more of the specified components and/or sub-components, and/or additional components. Sub-components can be implemented as components communicatively coupled to other components rather than included within parent components. One or more components and/or sub-components can be combined into a single component providing aggregate functionality. The components can interact with one or more other components not specifically described herein for the sake of brevity but known by those of skill in the art.

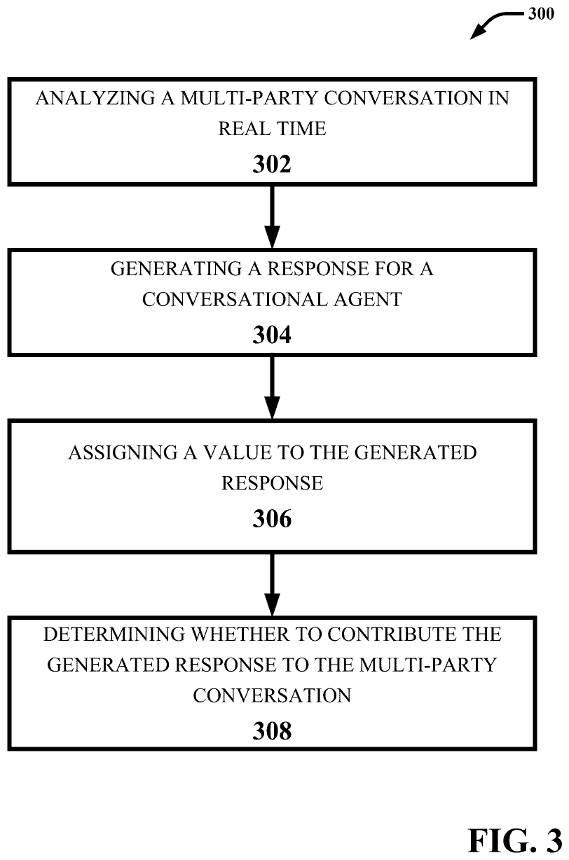

Next, FIG. 3 illustrates a flow diagram of a method 300 that can facilitate conversational agent participation in a multi-party conversation in accordance with some embodiments described herein, such as the system 200 of FIG. 2 and the system 100 of FIG. 1. While the method 300 is described relative to the system 200 of FIG. 2, the method 300 can be applicable also to other systems described herein. Repetitive description of like elements and/or processes employed in respective embodiments is omitted for sake of brevity.

For simplicity of explanation, the computer-implemented methods provided herein are depicted and/or described as a series of actions. It is to be understood that the subject matter is not limited by the actions illustrated and/or by the order thereof. For example, actions can occur in one or more orders, concurrently, and/or with other acts not presented and described herein. Furthermore, not all illustrated actions can be utilized to implement the computer-implemented methods in accordance with the described subject matter. In addition, the computer-implemented methods could alternatively be represented as a series of interrelated states via a state diagram or events. Additionally, the computer-implemented methods described in this specification are capable of being stored on an article of manufacture to facilitate transporting and transferring the computer-implemented methods to computers. The term article of manufacture, as used herein, encompasses a computer program accessible from any computer-readable device or storage media.

At 302, the method 300 includes analyzing a multi-party conversation in real time. The method 300 can use a system operatively coupled to a processor (e.g., analysis component 102) to analyze a multi-party conversation in real time.

At 304, method 300 includes generating a response for a conversational agent. The method 300 can use a system operatively coupled to the processor (e.g., generation component 106) to generate a response for a conversational agent.

At 306, method 300 includes assigning a value to the generated response. The method 300 can use a system operatively coupled to the processor (e.g., evaluation component 110) to assign a value to the generated response.

At 308, method 300 includes determining whether to contribute the generated response to the multi-party conversation. The method 300 can use a system operatively coupled to the processor (e.g., decision component 112) to determine whether to contribute the generated response to the multi-party conversation.

In some embodiments, method 300 is performed by a system, such as system 100 of FIG. 1 or system 200 of FIG. 2. Analyzing a multi-party conversation in real time 302 can be performed by an analysis component (e.g., analysis component 102 of FIG. 2). Generating a response for a conversational agent 304 can be performed by a generation component (e.g., generation component 106). Assigning a value to the generated response 306 can be performed by an evaluation component (e.g., evaluation component 110). Determining whether to contribute the generated response to the multi-party conversation 308 can be performed by a decision component (e.g., decision component 112).

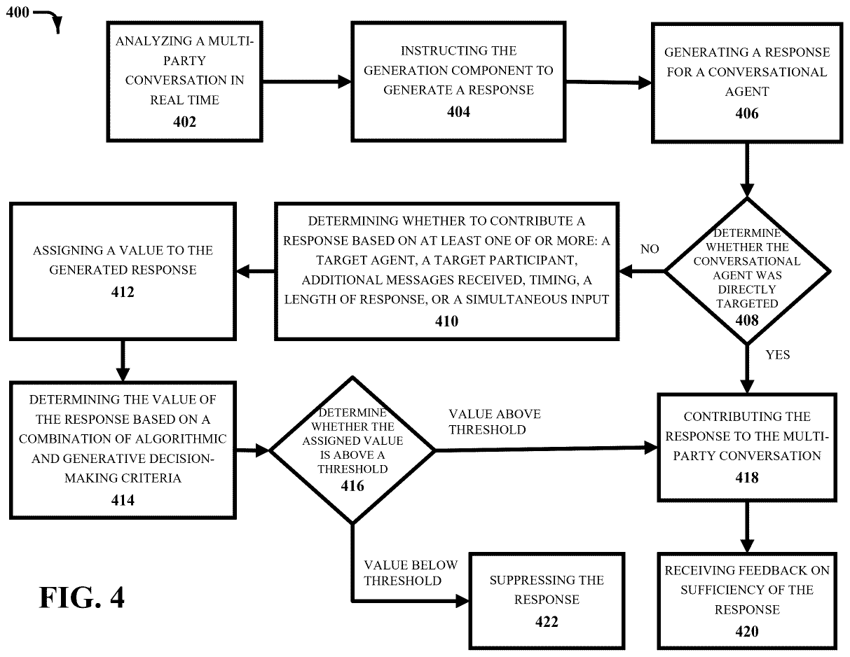

Next, FIG. 4 illustrates a flow diagram of a method 400 that can facilitate conversational agent participation in a multi-party conversation in accordance with some embodiments described herein. While the method 400 is described relative to the system 200 of FIG. 2, the method 400 can be applicable also to other systems described herein, such as the system 100 of FIG. 1.

At 402, the method 400 includes analyzing a multi-party conversation in real time. The method 400 can use a system operatively coupled to the processor (e.g., analysis component 102) to analyze a multi-party conversation in real time.

At 404, method 400 includes instructing the generation component to generate a response. The method 400 can use a system operatively coupled to the processor (e.g., analysis component 102) to instruct the generation component to generate a response.

At 406, method 400 includes generating a response for a conversational agent. The method 400 can use a system operatively coupled to the processor (e.g., generation component 106) to generate a response for a conversational agent.

At 408, method 400 includes a system determining whether the conversational agent was directly targeted. The method 400 can use a system operatively coupled to the processor (e.g., analysis component 102, evaluation component 110, decision component 112) to determine whether the conversational agent was directly targeted. If the system determines that a conversational agent was directly targeted, the method proceeds to step 418, where a response is contributed to the multi-party conversation. If the system determines that a conversational agent was not directly targeted, the method proceeds to step 410, where a system can further determine whether to contribute the response to the multi-party conversation based on various factors.

At 410, method 400 includes determining whether to contribute a response based on at least one of or more: a target agent, a target participant, additional messages received, timing, a length of response, or a simultaneous input. The method 400 can use a system operatively coupled to the processor (e.g., evaluation component 110, decision component 112) to determine whether to contribute a response based on at least one of or more: a target agent, a target participant, additional messages received, timing, a length of response, or a simultaneous input.

At 412, method 400 includes assigning a value to the generated response. The method 400 can use a system operatively coupled to the processor (e.g., evaluation component 110) to assign a value to the generated response.

At 414, method 400 includes determining the value of the response based on a combination of algorithmic and generative decision-making criteria. The method 400 can use a system operatively coupled to the processor (e.g., evaluation component 110, decision component 112) to determine the value of the response based on a combination of algorithmic and generative decision-making criteria.

At 416, the method 400 includes a system determining whether the assigned value is above a threshold. The method 400 can use a system operatively coupled to the processor (e.g., decision component 112) to determine whether the assigned value is above a threshold. If the system determines that the value of the response is above the threshold, the method proceeds to step 418, where a conversational agent response is contributed. If the system determines that the value of the response is below the threshold, the method proceeds to step 420, where the response is suppressed.

At 418, method 400 includes contributing the response to the multi-party conversation. The method 400 can use a system operatively coupled to the processor (e.g., decision component 112) to contribute the response to the multi-party conversation.

At 420, method 400 includes receiving feedback on sufficiency of the conversational agent response. The method 400 can use a system operatively coupled to the processor (e.g., feedback component 202) to receive feedback on sufficiency of the conversational agent response.

At 422, the method 400 includes suppressing the response. The method 400 can use a system operatively coupled to the processor (e.g., decision component 112) to suppress the response.

One or more systems, devices, computer program products, and/or computer-implemented methods provided herein relate to proactive conversational agent participation in a multi-party conversation. A system can include a processor that executes computer executable components stored in memory. The computer executable components can comprise a conversational agent that participates in a multi-party conversation, and that interacts with other system components. The computer executable components can further comprise an analysis component that analyzes a multi-party conversation in real time. The computer executable components can further comprise a generation component that generates a response for a conversational agent. The computer executable components can further comprise an evaluation component that assigns a value to the generated response. The computer executable components can further comprise a decision component that determines whether to contribute the generated response to the multi-party conversation. The computer executable components can comprise a feedback component that receives feedback on sufficiency of the response.

Advantages of this system can include improved context-aware participation, reduced computational overhead, or enhanced user experience in multi-party conversations.

In some embodiments, the analysis component can instruct a generation component to generate a conversational agent response. In some embodiments, if the analysis component determines that a conversational agent response is warranted, such as when a conversational agent is directly targeted, the analysis component can prompt the generation component accordingly.

According to some embodiments, the evaluation component can determine the value of the response based on a combination of algorithmic and generative decision-making criteria.

In various embodiments, the decision component can determine whether the assigned value is above a threshold. The threshold can adjust how frequently or to what extent a conversational agent contributes to a multi-party conversation. This capability can allow customization so different applications can tune a conversational agent's behavior to fit conversation needs. In various embodiments, the threshold can be based on at least one of or more: a minimum value amount, a minimum time between responses, a maximum acceptable response length, a relevant criterion associated with conversation dynamics, a user characteristic, or a contextual factor external to the multi-party conversation. A minimum value amount can prevent a conversational agent from responding to low-priority or redundant messages. A minimum time between responses can enforce a time delay between conversational agent contributions to avoid overwhelming a conversation. A maximum acceptable response length can limit how long a response can be to prevent overly verbose or disruptive messages. A relevant criterion associated with conversation dynamics can include factors such as a conversational turn-taking sequence, a sentiment analysis of previous exchanges, or a conversational agent's role within a dialogue. For example, in professional discussions, a conversational agent may prioritize responses that align with a discourse's formal tone and structure. A user characteristic can include attributes such as user expertise level, engagement history, or preferences for interaction style. For instance, a system interacting with a novice user may prioritize more detailed explanations, whereas an expert may receive more concise responses. A contextual factor external to the multi-party conversation may include real-world events, environmental conditions, or situational constraints that influence necessity or relevance of a response. For example, in an emergency scenario, a conversational agent may prioritize brevity and urgency, whereas in a casual chat setting, it may allow for more flexible and engaging interactions.

In some embodiments, the decision component can determine that the value is below the threshold, and the system can suppress the response. In various embodiments, the decision component can determine that the value is above the threshold, and the system can contribute the response to the multi-party conversation. According to some embodiments, the decision component can contribute the response to the multi-party conversation when a conversational agent is directly targeted. In various embodiments, the decision component can determine whether to contribute a response based on at least one of or more: a target agent, a target participant, additional messages received, timing, a length of response, or a simultaneous input. The decision component can analyze whether the conversational agent was being explicitly requested to respond (as it was a target of a message) or whether a message was directed at another specific user (target participant) in which case the conversational agent should not respond. A system can also consider whether additional messages provide more context before generating a response or whether timing of a message suggests a natural point for a conversational agent to interject. For example, detecting lulls in the conversation can provide an opportunity for the conversational agent to make contributions to keep a conversation moving along. Additionally, constraints such as length of a message and concurrent inputs from multiple participants can be used to determine whether a conversational agent's contribution would enhance or disrupt a multi-party conversation. By considering these factors, a system can attempt to ensure that a conversational agent engages only when its input is contextually appropriate and beneficial to a discussion.

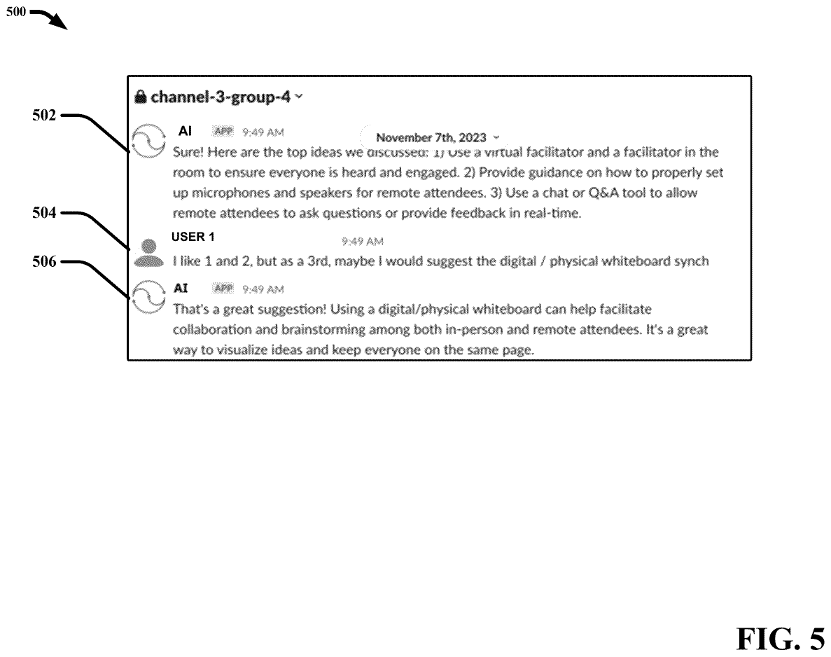

FIG. 5 illustrates an example of feedback on a conversational agent's response within a multi-party conversation, in accordance with some embodiments described herein.

FIG. 5 further depicts a multi-party conversation occurring in a work-related context, where multiple participants engage in a discussion. At 502, a conversational agent (AI) summarizes, and recaps key ideas discussed within a multi-party conversation. This summary enhances collaboration by ensuring participants clearly understand the main points exchanged in the conversation.

At 504, User 1 provides feedback on a conversational agent's (AI) summary at 502, indicating whether a response was accurate, relevant, or in need of modification. The system detects that User 1 submitted feedback to a conversational agent (AI), triggering an internal evaluation. Based on this feedback, the system assesses whether adjustments are necessary to refine a conversational agent's response.

At 506, a conversational agent (AI) generates a response.

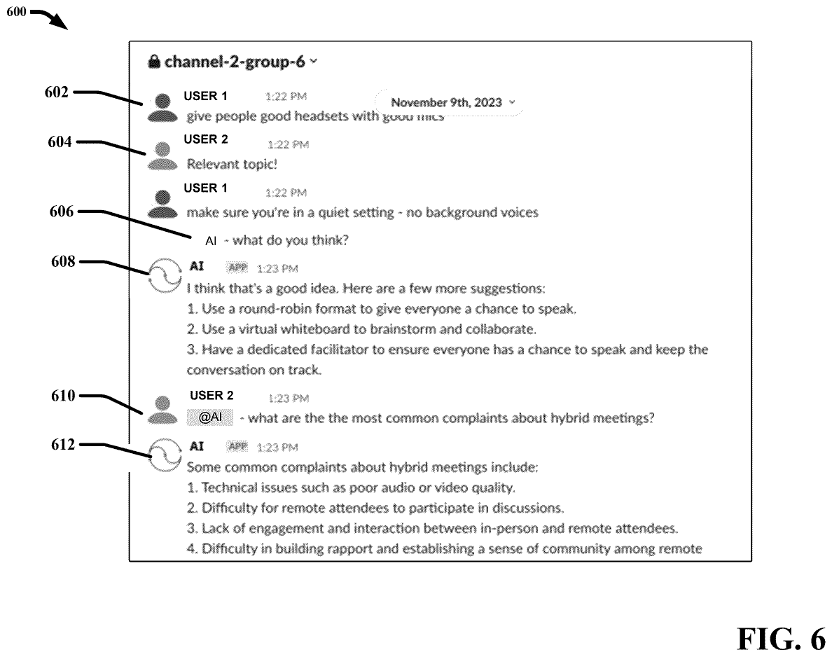

FIG. 6 illustrates an example of a multi-party conversation where a conversational agent is directly targeted, in accordance with some embodiments described herein.

At 602 and 604, User 1 and User 2 interact with each other while AI, which represents a conversational agent, remains inactive. The system evaluates the ongoing exchange and determines that a conversational agent's intervention is unnecessary, as neither participant has directly targeted a conversational agent, and it has nothing of value to add. By withholding a response in this scenario, the system ensures that a conversation flows naturally without unnecessary interruptions from a conversational agent (AI).

At 606, User 1 explicitly addresses a conversational agent (AI), requesting a response. The system detects that a conversational agent (AI) has been directly targeted and subsequently triggers a response generation process. At 608, a conversational agent (AI) generates and provides a reply based on received input, ensuring that its contribution is contextually relevant to an ongoing discussion.

At 610, User 2 poses a follow-up question directed at a conversational agent (AI). The system detects that a conversational agent (AI) has been directly targeted and triggers a follow-up response at 612.

FIG. 6 illustrates an example mechanism by which a system identifies direct interactions with a conversational agent (AI) within a multi-party conversation. In various embodiments, a conversational agent can proactively contribute to a multi-party conversation when a conversational agent has not been directly addressed.

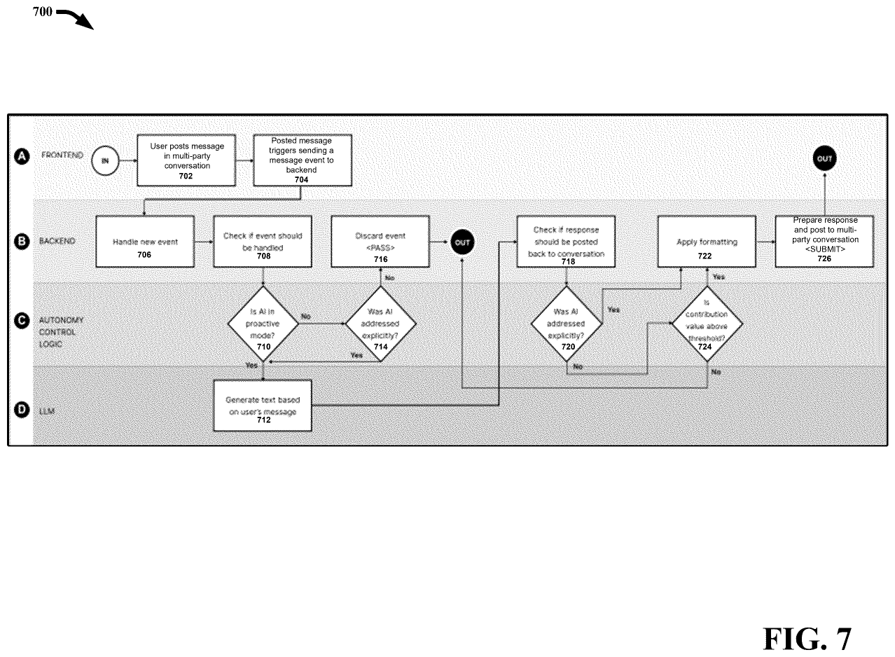

FIG. 7 illustrates an example system workflow for a conversational agent's participation in a multi-party conversation in accordance with some embodiments described herein.

Method 700 includes multiple processing stages, which can be distributed across different system components. Operations 702 and 704 occur at the front end, handling initial user interactions. Operations 706, 708, 716, 718, 722, and 726 are processed in the backend, managing event handling and response generation. Additionally, operation 712 can be handled within a large language model (LLM) to generate textual responses based on a user's input.

At 702, a user posts a message within a multi-party conversation. A message can be directed toward a specific user, a conversational agent, or a group at large. The system can receive a user-generated input and prepare it for processing.

At 704, a posted message triggers a generation of a message event, which can be transmitted to the backend for further processing. This event can encapsulate relevant metadata, including sender identity, timestamp, conversational context, or any direct mentions of a conversational agent.

At 706, a system can receive and processes a new event, determining its significance and potential need for conversational agent intervention.

At 708, a system can evaluate whether an event should be handled further or discarded. This decision can be based on factors such as message content, sender permissions, or conversational context. If a message lacks relevance to a conversational agent's role, a system can opt to discard an event.

At 710, a system can determine whether a conversational agent (AI) is in proactive mode. If a conversational agent is in proactive mode, a system can proceed to step 712, where a response is generated autonomously. If a conversational agent is not in proactive mode, a system can proceed to 714 for further evaluation.

At 714, a system can check whether a conversational agent was explicitly addressed in a message. Explicit targeting may occur through direct mentions, specific commands, or contextual cues indicating that a response is expected from a conversational agent.

At 716, if a conversational agent was not explicitly addressed and proactive engagement is not required, a system can discard an event (<Pass>), ensuring that a conversational agent does not disrupt a conversation with unnecessary responses. A process then can exit.

At 712, if a conversational agent is in proactive mode or a system can determine that a conversational agent should contribute, a large language model can generate a response based on a user's message. A large language model analyzes the input context, conversation history, and potential response options before constructing a reply. Once generated, a response can move to step 718.

At 718, a system can evaluate whether a generated response should be posted back to a multi-party conversation. This determination can involve assessing relevance of a response to a conversation, checking for redundancy or whether similar responses have already been provided, or ensuring compliance with engagement thresholds to prevent excessive conversational agent intervention.

At 720, a system again can evaluate whether a conversational agent was explicitly addressed. If a message was directly intended for a conversational agent, a system can proceed to 722. If not, it can proceed to 724, where further contribution analysis can be performed.

At 722, if a conversational agent was explicitly addressed, a system can apply formatting to ensure a response is structured appropriately for readability or clarity. This can involve style adjustments (e.g., bolding key terms, structuring lists), concise phrasing optimizations to improve clarity, or adding citations or references if necessary.

At 724, if a conversational agent was not explicitly addressed, a system can determine whether a contribution value of a response exceeds a predefined threshold. This threshold-based evaluation regulates a conversational agent's participation to ensure meaningful engagement. If a contribution value is below a predefined threshold, a process can exit without posting a response. If a contribution value meets or exceeds a predefined threshold, a system can proceed to 722, where response formatting can be applied before submission.

At 726, a system can prepare a response for submission and posts it to a multi-party conversation.

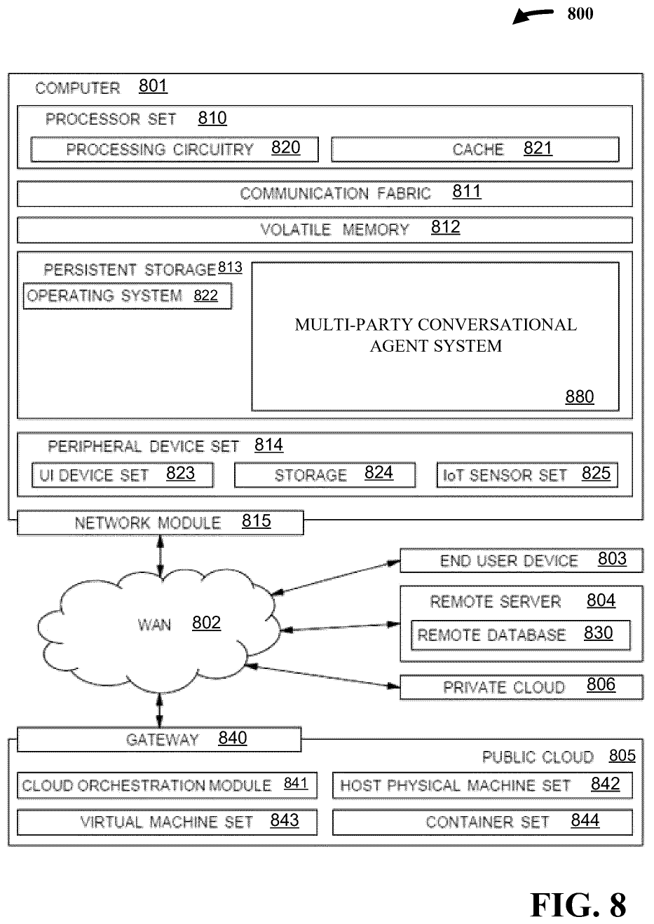

FIG. 8 and the following discussion are intended to provide a brief, general description of a suitable computing environment 800 in which some embodiments described herein can be implemented. For example, various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks can be performed in reverse order, as a single integrated step, concurrently or in a manner at least partially overlapping in time.

A computer program product embodiment (“CPP embodiment” or “CPP”) is a term used in the present disclosure to describe any set of one, or more, storage media (also called “mediums”) collectively included in a set of one or more storage devices that collectively include machine readable code corresponding to instructions and/or data for performing computer operations specified in a given CPP claim. A “storage device” is any tangible device that can retain and store instructions for use by a computer processor. Without limitation, the computer readable storage medium can be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those skilled in the art, data is typically moved at some occasional points in time during normal operations of a storage device, such as during access, de-fragmentation or garbage collection, but this does not render the storage device as transitory because the data is not transitory while it is stored.

Computing environment 800 contains an example of an environment for the execution of at least some of the computer code involved in performing the inventive methods, with multi-party conversational agent system code 880. In addition to block 880, computing environment 800 includes, for example, computer 801, wide area network (WAN) 802, end user device (EUD) 803, remote server 804, public cloud 805, and private cloud 806. In this embodiment, computer 801 includes processor set 810 (including processing circuitry 820 and cache 821), communication fabric 811, volatile memory 812, persistent storage 813 (including operating system 822 and block 845, as identified above), peripheral device set 814 (including user interface (UI), device set 823, storage 824, and Internet of Things (IoT) sensor set 825), and network module 815. Remote server 804 includes remote database 830. Public cloud 805 includes gateway 840, cloud orchestration module 841, host physical machine set 842, virtual machine set 843, and container set 844.

COMPUTER 801 can take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 830. As is well understood in the art of computer technology, and depending upon the technology, performance of a computer-implemented method can be distributed among multiple computers and/or between multiple locations. Detailed discussion focuses on a single computer, specifically computer 801, to maintain simplicity. Computer 801 can be located in a cloud, even though it is not shown in a cloud in FIG. 8. On the other hand, computer 801 is not required to be in a cloud except to any extent as can be affirmatively indicated.

PROCESSOR SET 810 includes one, or more, computer processors of any type now known or to be developed in the future. Processing circuitry 820 can be distributed over multiple packages, for example, multiple, coordinated integrated circuit chips. Processing circuitry 820 can implement multiple processor threads and/or multiple processor cores. Cache 821 is memory that is located in the processor chip package(s) and is typically used for data or code that should be available for rapid access by the threads or cores running on processor set 810. Cache memories are typically organized into multiple levels depending upon relative proximity to the processing circuitry. Alternatively, some, or all, of the cache for the processor set can be located “off chip.” In some computing environments, processor set 810 can be designed for working with qubits and performing quantum computing.

Computer readable program instructions are typically loaded onto computer 801 to cause a series of operational steps to be performed by processor set 810 of computer 801 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 821 and the other storage media discussed below. The program instructions, and associated data, are accessed by processor set 810 to control and direct performance of the inventive methods. In computing environment 800, at least some of the instructions for performing the inventive methods can be stored in block 845 in persistent storage 813.

COMMUNICATION FABRIC 811 is the signal conduction path that allows the various components of computer 801 to communicate with each other. Typically, this fabric is made of switches and electrically conductive paths, such as the switches and electrically conductive paths that make up buses, bridges, physical input/output ports and the like. Other types of signal communication paths can be used, such as fiber optic communication paths and/or wireless communication paths.

VOLATILE MEMORY 812 is any type of volatile memory now known or to be developed in the future. Examples include dynamic type random access memory (RAM) or static type RAM. Typically, the volatile memory is characterized by random access, but this is not required unless affirmatively indicated. In computer 801, the volatile memory 812 is located in a single package and is internal to computer 801, but, alternatively or additionally, the volatile memory can be distributed over multiple packages and/or located externally with respect to computer 801.

PERSISTENT STORAGE 813 is any form of non-volatile storage for computers that is now known or to be developed in the future. The non-volatility of this storage means that the stored data is maintained regardless of whether power is being supplied to computer 801 and/or directly to persistent storage 813. Persistent storage 813 can be a read only memory (ROM), but typically at least a portion of the persistent storage allows writing of data, deletion of data and re-writing of data. Some familiar forms of persistent storage include magnetic disks and solid-state storage devices. Operating system 822 can take several forms, such as various known proprietary operating systems or open-source Portable Operating System Interface type operating systems that employ a kernel. The code included in block 845 typically includes at least some of the computer code involved in performing the inventive methods.

PERIPHERAL DEVICE SET 814 includes the set of peripheral devices of computer 801. Data communication connections between the peripheral devices and the other components of computer 801 can be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 823 can include components such as a display screen, speaker, microphone, wearable devices (such as goggles and smart watches), keyboard, mouse, printer, touchpad, game controllers, and haptic devices. Storage 824 is external storage, such as an external hard drive, or insertable storage, such as an SD card. Storage 824 can be persistent and/or volatile. In some embodiments, storage 824 can take the form of a quantum computing storage device for storing data in the form of qubits. In embodiments where computer 801 is required to have a large amount of storage (for example, where computer 801 locally stores and manages a large database) then this storage can be provided by peripheral storage devices designed for storing large amounts of data, such as a storage area network (SAN) that is shared by multiple, geographically distributed computers. IoT sensor set 825 is made up of sensors that can be used in Internet of Things applications. For example, one sensor can be a thermometer, and another sensor can be a motion detector.

NETWORK MODULE 815 is the collection of computer software, hardware, and firmware that allows computer 801 to communicate with other computers through WAN 802. Network module 815 can include hardware, such as modems or Wi-Fi signal transceivers, software for packetizing and/or de-packetizing data for communication network transmission, and/or web browser software for communicating data over the internet. In some embodiments, network control functions and network forwarding functions of network module 815 are performed on the same physical hardware device. In other embodiments (for example, embodiments that utilize software-defined networking (SDN)), the control functions and the forwarding functions of network module 815 are performed on physically separate devices, such that the control functions manage several different network hardware devices. Computer readable program instructions for performing the inventive methods can typically be downloaded to computer 801 from an external computer or external storage device through a network adapter card or network interface included in network module 815.

WAN 802 is any wide area network (for example, the internet) capable of communicating computer data over non-local distances by any technology for communicating computer data, now known or to be developed in the future. In some embodiments, the WAN can be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 803 is any computer system that is used and controlled by an end user (for example, a customer of an enterprise that operates computer 801) and can take any of the forms discussed above in connection with computer 801. EUD 803 typically receives helpful and useful data from the operations of computer 801. For example, in a hypothetical case where computer 801 is designed to provide a recommendation to an end user, this recommendation would typically be communicated from network module 815 of computer 801 through WAN 802 to EUD 803. In this way, EUD 803 can display, or otherwise present, the recommendation to an end user. In some embodiments, EUD 803 can be a client device, such as thin client, heavy client, mainframe computer and/or desktop computer.

REMOTE SERVER 804 is any computer system that serves at least some data and/or functionality to computer 801. Remote server 804 can be controlled and used by the same entity that operates computer 801. Remote server 804 represents the machine(s) that collect and store helpful and useful data for use by other computers, such as computer 801. For example, in a hypothetical case where computer 801 is designed and programmed to provide a recommendation based on historical data, then this historical data can be provided to computer 801 from remote database 830 of remote server 804.

PUBLIC CLOUD 805 is any computer system available for use by multiple entities that provides on-demand availability of computer system resources and/or other computer capabilities, especially data storage (cloud storage) and computing power, without direct active management by the scale. The direct and active management of the computing resources of public cloud 805 is performed by the computer hardware and/or software of cloud orchestration module 841. The computing resources provided by public cloud 805 are typically implemented by virtual computing environments that run on various computers making up the computers of host physical machine set 842, which is the universe of physical computers in and/or available to public cloud 805. The virtual computing environments (VCEs) typically take the form of virtual machines from virtual machine set 843 and/or containers from container set 844. It is understood that these VCEs can be stored as images and can be transferred among and between the various physical machine hosts, either as images or after instantiation of the VCE. Cloud orchestration module 841 manages the transfer and storage of images, deploys new instantiations of VCEs and manages active instantiations of VCE deployments. Gateway 840 is the collection of computer software, hardware and firmware allowing public cloud 805 to communicate through WAN 802.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 806 is similar to public cloud 805, except that the computing resources are only available for use by a single enterprise. While private cloud 806 is depicted as being in communication with WAN 802, in other embodiments a private cloud can be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1175 and private cloud 1176 are both part of a larger hybrid cloud. The embodiments described herein can be directed to one or more of a system, a method, an apparatus, and/or a computer program product at any possible technical detail level of integration. The computer program product can include a computer readable storage medium (or media) having computer readable program instructions thereon for causing a processor to carry out aspects of some of the embodiments described herein. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a superconducting storage device and/or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon and/or any suitable combination of the foregoing. A computer readable storage medium, as used herein, is not to be construed as being transitory signals per se, such as radio waves and/or other freely propagating electromagnetic waves, electromagnetic waves propagating through a waveguide and/or other transmission media (e.g., light pulses passing through a fiber-optic cable), and/or electrical signals transmitted through a wire.

Computer readable program instructions described herein can be downloaded to respective computing/processing devices from a computer readable storage medium and/or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer-readable instructions for carrying out operations of some embodiments herein can be assembler instructions, instruction-set-architecture (ISA) instructions, machine instructions, machine dependent instructions, microcode, firmware instructions, state-setting data, configuration data for integrated circuitry, and/or source code and/or object code written in any combination of one or more programming languages, including an object oriented programming language such as Smalltalk, C++ or the like, and/or procedural programming languages, such as the “C” programming language and/or similar programming languages. The computer readable program instructions can execute entirely on a computer, partly on a computer, as a stand-alone software package, partly on a computer and/or partly on a remote computer or entirely on the remote computer and/or server. In the latter scenario, the remote computer can be connected to a computer through any type of network, including a local area network (LAN) and/or a wide area network (WAN), and/or the connection can be made to an external computer (for example, through the Internet using an Internet Service Provider). In some embodiments, electronic circuitry including, for example, programmable logic circuitry, field-programmable gate arrays (FPGA) and/or programmable logic arrays (PLA) can execute the computer readable program instructions by utilizing state information of the computer readable program instructions to personalize the electronic circuitry, in order to perform aspects of some of the embodiments described herein.

Aspects of some of the embodiments described herein are described with reference to flowchart illustrations and/or block diagrams of methods, apparatus (systems), and computer program products according to some embodiments described herein. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general-purpose computer, special purpose computer and/or other programmable data processing apparatus to produce a machine, such that the instructions, which execute via the processor of the computer or other programmable data processing apparatus, can create means for implementing the functions/acts specified in the flowchart and/or block diagram block or blocks. These computer readable program instructions can also be stored in a computer readable storage medium that can direct a computer, a programmable data processing apparatus and/or other devices to function in a particular manner, such that the computer readable storage medium having instructions stored therein can comprise an article of manufacture including instructions which can implement aspects of the function/act specified in the flowchart and/or block diagram block or blocks. The computer readable program instructions can also be loaded onto a computer, other programmable data processing apparatus and/or other device to cause a series of operational acts to be performed on the computer, other programmable apparatus and/or other device to produce a computer implemented process, such that the instructions which execute on the computer, other programmable apparatus and/or other device implement the functions/acts specified in the flowchart and/or block diagram block or blocks.

The flowcharts and block diagrams in the figures illustrate the architecture, functionality, and/or operation of possible implementations of systems, computer-implementable methods, and/or computer program products according to some embodiments described herein. In this regard, each block in the flowchart or block diagrams can represent a module, segment, and/or portion of instructions, which comprises one or more executable instructions for implementing the specified logical function. In one or more alternative implementations, the functions noted in the blocks can occur out of the order noted in the Figures. For example, two blocks shown in succession can be executed substantially concurrently, and/or the blocks can sometimes be executed in the reverse order, depending upon the functionality involved. It will also be noted that each block of the block diagrams and/or flowchart illustration, and/or combinations of blocks in the block diagrams and/or flowchart illustration, can be implemented by special purpose hardware-based systems that can perform the specified functions and/or acts and/or carry out one or more combinations of special purpose hardware and/or computer instructions.

While the subject matter has been described above in the general context of computer-executable instructions of a computer program product that runs on a computer and/or computers, those skilled in the art will recognize that some of the embodiments herein also can be implemented at least partially in parallel with one or more other program modules. Generally, program modules include routines, programs, components, and/or data structures that perform particular tasks and/or implement particular abstract data types. Moreover, the described computer-implemented methods can be practiced with other computer system configurations, including single-processor and/or multiprocessor computer systems, mini-computing devices, mainframe computers, as well as computers, hand-held computing devices (e.g., PDA, phone), and/or microprocessor-based or programmable consumer and/or industrial electronics. The illustrated aspects can also be practiced in distributed computing environments in which tasks are performed by remote processing devices that are linked through a communications network. However, one or more, if not all aspects of the embodiments described herein can be practiced on stand-alone computers. In a distributed computing environment, program modules can be located in both local and remote memory storage devices.

As used in this application, the terms “component,” “system,” “platform” and/or “interface” can refer to and/or can include a computer-related entity or an entity related to an operational machine with one or more specific functionalities. The entities described herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system and/or across a network such as the Internet with other systems via the signal). As another example, a component can be an apparatus with specific functionality provided by mechanical parts operated by electric or electronic circuitry, which is operated by a software and/or firmware application executed by a processor. In such a case, the processor can be internal and/or external to the apparatus and can execute at least a part of the software and/or firmware application. As yet another example, a component can be an apparatus that provides specific functionality through electronic components without mechanical parts, where the electronic components can include a processor and/or other means to execute software and/or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter described herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit and/or device comprising, but not limited to, single-core processors; single-processors with software multithread execution capability; multi-core processors; multi-core processors with software multithread execution capability; multi-core processors with hardware multithread technology; parallel platforms; and/or parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, and/or any combination thereof designed to perform the functions described herein. Further, processors can exploit nano-scale architectures such as, but not limited to, molecular and quantum-dot based transistors, switches, and/or gates, in order to optimize space usage and/or to enhance performance of related equipment. A processor can be implemented as a combination of computing processing units.

Herein, terms such as “store,” “storage,” “data store,” data storage,” “database,” and substantially any other information storage component relevant to operation and functionality of a component are utilized to refer to “memory components,” entities embodied in a “memory,” or components comprising a memory. Memory and/or memory components described herein can be either volatile memory or nonvolatile memory or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory and/or nonvolatile random-access memory (RAM) (e.g., ferroelectric RAM (FeRAM). Volatile memory can include RAM, which can act as external cache memory, for example. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM) and/or Rambus dynamic RAM (RDRAM). Additionally, the described memory components of systems and/or computer-implemented methods herein are intended to include, without being limited to including, these and/or any other suitable types of memory.

What has been described above includes mere examples of systems and computer-implemented methods. It is, of course, not possible to describe every conceivable combination of components and/or computer-implemented methods for purposes of describing the various embodiments, but one of ordinary skill in the art can recognize that many further combinations and/or permutations of the various embodiments are possible. Furthermore, to the extent that the terms “includes,” “has,” “possesses,” and the like are used in the detailed description, claims, appendices and/or drawings such terms are intended to be inclusive in a manner similar to the term “comprising” as “comprising” is interpreted when employed as a transitional word in a claim.

The descriptions of the various embodiments have been presented for purposes of illustration but are not intended to be exhaustive or limited to the embodiments described herein. Many modifications and variations will be apparent to those of ordinary skill in the art without departing from the scope and spirit of the described embodiments. The terminology used herein was chosen to best explain the principles of the embodiments, the practical application and/or technical improvement over technologies found in the marketplace, and/or to enable others of ordinary skill in the art to understand the embodiments described herein.

What is claimed is:

1. A system, comprising:
a processor that executes computer executable components stored in memory, wherein the computer executable components comprise:
a conversational agent that participates in a multi-party conversation, and that interacts with other system components;
an analysis component that analyzes the multi-party conversation in real time;
a generation component that generates a response for the conversational agent;
an evaluation component that assigns a value to the generated response; and
a decision component that determines whether to contribute the generated response to the multi-party conversation.

2. The system of claim 1, wherein the analysis component further comprises instructing the generation component to generate a response.

3. The system of claim 1, wherein the evaluation component determines the value of the response based on a combination of algorithmic and generative decision-making criteria.

4. The system of claim 1, wherein the decision component determines whether the assigned value is above a threshold.

5. The system of claim 4, wherein the threshold is based on at least one of or more: a minimum value amount, a minimum time between responses, a maximum acceptable response length, a relevant criterion associated with conversation dynamics, a user characteristic, or a contextual factor external to the multi-party conversation.

6. The system of claim 4, wherein the decision component determines the value is below the threshold, and the system suppresses the response.

7. The system of claim 4, wherein the decision component determines the value is above the threshold, and the system contributes the response to the multi-party conversation.

8. The system of claim 1, wherein the decision component further comprises contributing the response to the multi-party conversation if a conversational agent is directly targeted.

9. The system of claim 1, wherein the decision component determines whether to contribute a response based on at least one of or more: a target agent, a target participant, additional messages received, timing, a length of response, or a simultaneous input.

10. The system of claim 1, further comprises a feedback component that receives feedback on sufficiency of the response.

11. A computer-implemented method that utilizes a processor that executes computer executable components stored in memory to perform the following acts:
analyzing a multi-party conversation in real time;
generating a response for a conversational agent;
assigning a value to the generated response; and
determining whether to contribute the generated response to the multi-party conversation.

12. The method of claim 11, further comprising instructing the generation component to generate a response.

13. The method of claim 11, further comprising determining the value of the response based on a combination of algorithmic and generative decision-making criteria.

14. The method of claim 11, further comprising determining whether the assigned value is above a threshold.

15. The method of claim 14, further comprising determining the value is below the threshold, and the system suppresses the response.

16. The method of claim 14, further comprising determining determines the value is above the threshold, and the system contributes the response to the multi-party conversation.

17. The method of claim 11, further comprising contributing the response to the multi-party conversation if the conversational agent is directly targeted.

18. The method of claim 11, further comprising determining whether to contribute a response based on at least one of or more: a target agent, a target participant, additional messages received, timing, a length of response, or a simultaneous input.

19. The method of claim 11, further comprising receiving feedback on sufficiency of the response.

20. A computer program product comprising a computer readable storage medium having program instructions embodied therewith, the program instructions executable by a processor to cause the processor to:
analyze a multi-party conversation in real time;
generate a response for a conversational agent;
assign a value to the generated response; and
determine whether to contribute the generated response to the multi-party conversation.
